(19) United States
(12) Patent Application Publication
(10) Pub. No.: US 2024/0155674 A1
(43) Pub. Date: May 9, 2024

(54) RECEIVE ASSISTED LISTEN BEFORE TALK WITH MULTIPLE CANDIDATE BEAMS

(71) Applicant: QUALCOMM Incorporated, San Diego, CA (US)

(72) Inventors: Giovanni CHISCI, San Diego, CA (US); Arumugam CHENDAMARAI KANNAN, San Diego, CA (US); Vinay CHANDE, San Diego, CA (US); Jing SUN, San Diego, CA (US); Siyi CHEN, Beijing (CN); Xiaoxia ZHANG, San Diego, CA (US)

(21) Appl. No.: 18/280,073

(22) PCT Filed: Apr. 5, 2021
(86) PCT No.: PCT/CN2021/085503

§ 371 Date: Sep. 1, 2023

(51) Int. Cl. H04W 74/0808; H04W 72/044

(52) U.S. Cl. CPC H04W 74/0808; H04W 72/046

(57) ABSTRACT

This disclosure provides systems, methods and apparatus, including computer programs encoded on computer storage media, for a user equipment (UE) to provide listen before talk (LBT) assistance to a transmitting device. The UE may receive a pre-grant (PG) indicating a plurality of beams and a transmission resource. The UE may performing a LBT procedure on each beam of the indicated plurality of beams. The UE may transmit an acknowledgment to the pre-grant (APG) including a LBT report for the indicated plurality of beams on the transmission resource, the LBT report indicating a result of the LBT procedure for each beam of the indicated plurality of beams.

### TECHNICAL FIELD

The present disclosure relates to wireless communications using receive assisted listen before talk (LBT) with multiple candidate beams.

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (such as with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method of wireless communication at an apparatus of a user equipment (UE). The method may include receiving a pre-grant (PG) indicating a plurality of beams and a transmission resource. The method may include performing a listen before talk (LBT) procedure on each beam of the indicated plurality of beams. The method may include transmitting an acknowledgment to the pre-grant (APG) including a LBT report for the indicated plurality of beams on the transmission resource, the LBT report indicating a result of the LBT procedure for each beam of the indicated plurality of beams.

The present disclosure also provides an apparatus (e.g., a UE) including a memory storing computer-executable instructions and at least one processor configured to execute the computer-executable instructions to perform the above method, an apparatus including means for performing the above method, and a non-transitory computer-readable medium storing computer-executable instructions for performing the above method.

One innovative aspect of the subject matter described in this disclosure can be implemented in a method of wireless communication at an apparatus of a base station (BS). The method may include transmitting a PG indicating a plurality of beams and a transmission resource to a user equipment UE. The method may include receiving an APG on the transmission resource, the APG including a LBT report indicating a result of a LBT procedure for each beam of the indicated plurality of beams.

The present disclosure also provides an apparatus (e.g., a BS) including a memory storing computer-executable instructions and at least one processor configured to execute the computer-executable instructions to perform the above method, an apparatus including means for performing the above method, and a non-transitory computer-readable medium storing computer-executable instructions for performing the above method.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a diagram illustrating an example of a wireless communications system and an access network.

FIG. 2A is a diagram illustrating an example of a first frame.

FIG. 2B is a diagram illustrating an example of DL channels within a subframe.

FIG. 2C is a diagram illustrating an example of a second frame.

FIG. 2D is a diagram illustrating an example of a subframe.

FIG. 3 is a diagram illustrating an example of a base station (BS) and user equipment (UE) in an access network.

FIG. 4A is a diagram illustrating example messages for a channel access procedure with LBT receiver assistance for a transmitter channel occupancy time.

FIG. 4B is a diagram illustrating example messages for a channel access procedure with LBT receiver assistance for a receiver channel occupancy time.

FIG. 5 is a diagram illustrating example messages for a channel access procedure with LBT receiver assistance for multiple beams.

FIG. 6 is a diagram illustrating example signaling of multiple beams for a channel access procedure with LBT receiver assistance.

FIG. 7 is a conceptual data flow diagram illustrating the data flow between different means/components in an example BS.

FIG. 8 is a conceptual data flow diagram illustrating the data flow between different means/components in an example UE.

FIG. 9 is a flowchart of an example method for a UE to perform multi-beam LBT to assist channel access.

FIG. 10 is a flowchart of an example method for a BS to access a channel with multi-beam LBT assistance from a UE.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. Some of the examples in this disclosure are based on wireless and wired local area network (LAN) communication according to the Institute of Electrical and Electronics Engineers (IEEE) 802.11 wireless standards, the IEEE 802.3 Ethernet standards, and the IEEE 1901 Powerline communication (PLC) standards. However, the described implementations may be implemented in any device, system or network that is capable of transmitting and receiving RF signals according to any of the wireless communication standards, including any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

Access to a wireless communication channel in unlicensed spectrum may be conditioned on a listen before talk (LBT) procedure or a clear channel assessment (CCA) procedure. In higher frequency bands such as a 60 GHz unlicensed band (Fr2x), a narrow beamforming operation may be utilized to close a link between a transmitter and receiver. Conventionally, a LBT/CCA procedure is performed by a transmitting device. When narrow beamforming is used, however, the transmitter side channel sensing may not represent the interference level that the receiver will experience. One proposal to improve channel access is for the receiver to provide assistance information (signaling) to the transmitter only. That is, the receiver does not communicate with potential interfering devices.

For the Fr2x band, a channel access procedure may define a channel occupancy time (COT) for transmitting data that is subject to the LBT/CCA procedures and short control signalling that is exempt from contention. For example, the European Telecommunications Standards Institute (ETSI) has proposed the ETSI EN 302 567 standard for the 60 GHz band. In particular, to initiate a COT, the initiating device may perform a CCA check, which may be referred to as a long CCA, an extended CCA (eCCA), or a category 4 LBT procedure. As used herein, the terms long CCA, eCCA, and category 4 LBT refer to performing multiple checks on a transmission medium (e.g., a channel or a beam). For example, a long CCA may include generating a random counter within a range, determining whether the channel is idle for an observation window (e.g., 8 μs or 5 μs), and decrementing the counter if the channel is idle. The energy detection threshold (ED) for the CCA may be −80 dBm+10× log 10 (Operating Channel Bandwidth (in MHz))+10×log 10 (Pmax/Pout), where Pmax is the RF output power limit in Watts (W) for effective isotropic radiated power (EIRP) and Pout is the RF output power in W for EIRP. In contrast a short CCA or category 2 LBT procedure may refer to a single check of the transmission medium. A short CCA or category 2 LBT procedure may not result in a new COT. The initiating device may obtain the COT and access the channel when the counter reaches 0. After passing the CCA check, the initiating device can share the COT with responding devices. The responding device may not be required to do any CCA check to share the COT. There may not be a requirement on a length of a gap between the initiating device and responding device transmissions. For short control signalling, a device may transmit control messages as contention-free transmissions for a limited period (e.g., 10 ms) over a window (e.g., 100 ms).

Receiver side sensing may be used to check the interference condition at the receiver of the data traffic when LBT/CCA is required. For an UL traffic COT, the gNB acquires the COT with a Cat4 LBT (countdown based). This intrinsically includes Rx Assistance because the gNB is the receiver of the data. For DL traffic COT, there are two ways to obtain Rx Assistance. First, the gNB may be the initiator and obtain a COT with a Cat4 LBT, then send a pre-grant (PG) requesting an LBT (Cat2 or Cat4) from the UE for confirming the good channel conditions if DL data is sent. If the LBT passes, the UE may send a hard acknowledgment-to-pre-grant (APG). Detection of the hard APG at the gNB confirms to the gNB the possibility of sending data to the UE. Second, the gNB may send the PG under the short control signaling clause as a contention-exempt transmission (with optional Cat2 LBT). The gNB may request the UE to perform a Cat4 LBT to initiate a COT, which the UE will share by sending the APG back in case of success.

Previous proposals use different forms of DCIs with single resource indication as a pre-grant to trigger an LBT and, upon success, an APG on the single indicated resource. This means that if multiple beams are to be tried, multiple PG/APG handshakes are performed, with the consequent prolonging of the timeline before the DL data transmissions can start.

In an aspect, the present disclosure provides for a receiving device such as a user equipment (UE) to receive a single PG, perform an LBT procedure on multiple beams, and provide a full report to the transmitting device (e.g., a base station or gNB) in a single APG. The PG may indicate the multiple beams and a transmission resource for the APG. The APG may indicate a result of the LBT procedure for each beam. In an aspect where the result for at least one beam is a successful LBT procedure, the transmitting device may be able to schedule the receiving device to receive a downlink transmission on any beam with a successful LBT procedure. Each beam may be associated with a COT defined based on an LBT procedure and a maximum channel occupancy time (MCOT) value.

Particular implementations of the subject matter described in this disclosure can be implemented to realize one or more of the following potential advantages. The LBT procedure for multiple beams may allow greater flexibility in resource allocation and scheduling downlink transmissions. The use of a single PG and APG may provide the flexibility without increasing signaling overhead. Additionally, transmissions may be more reliable because conditions at the receiver are known and beam collisions can be managed. Accordingly, the disclosed subject matter provides efficient use of spectrum and/or enhanced throughput. The scheduled transmissions may comply with regulations that require LBT procedures.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. The processor may include an interface or be coupled to an interface that can obtain or output signals. The processor may obtain signals via the interface and output signals via the interface. In some implementations, the interface may be a printed circuit board (PCB) transmission line. In some other implementations, the interface may include a wireless transmitter, a wireless transceiver, or a combination thereof. For example, the interface may include a radio frequency (RF) transceiver which can be implemented to receive or transmit signals, or both. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example implementations, the functions described may be implemented in hardware, software, or any combination thereof. If implemented in software, the functions may be stored on or encoded as one or more instructions or code on a computer-readable medium. Computer-readable media includes computer storage media, which may be referred to as non-transitory computer-readable media. Non-transitory computer-readable media may exclude transitory signals. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

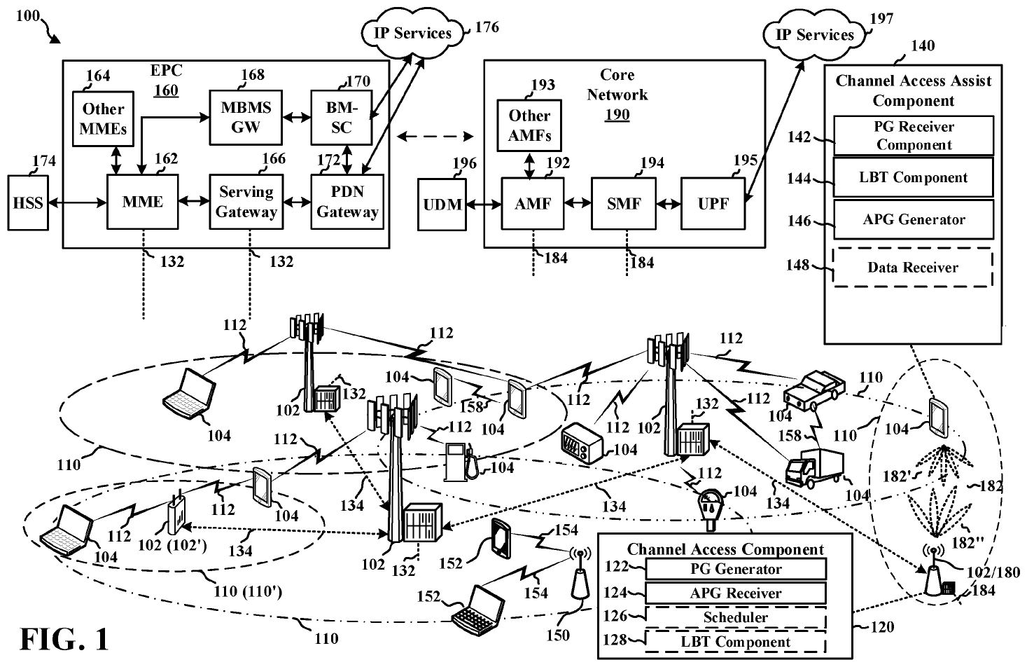

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (such as a 5G Core (5GC)). The base stations 102 may include macrocells (high power cellular base station) or small cells (low power cellular base station). The macrocells include base stations. The small cells include femtocells, picocells, and microcells.

In some implementations, one or more of the UEs 104 may include a channel access assist component 140 that provides receiver side beam information. The channel access assist component 140 may include a PG receiver component 142 configured to receive a PG indicating a plurality of beams and a transmission resource. The channel access assist component 140 may include a LBT component 144 configured to perform a LBT procedure on each beam of the indicated plurality of beams. The channel access assist component 140 may include an APG generator 146 configured to transmit an APG including a LBT report for the indicated plurality of beams on the transmission resource. The LBT report may indicate a result of the LBT procedure for each beam of the indicated plurality of beams. In some implementations, the channel access assist component 140 may optionally include a data receiver 148 configured to receive a downlink transmission on the at least one beam during a COT.

In some implementations, one or more of the base stations 102 may include a channel access component 120 configured to access a channel based on LBT assistance from a receiving device. The channel access component 120 may include a PG generator 122 configured to configure a UE to measure CSI metrics based on CSI-RS and/or SSBs. The channel access component 120 may include an APG receiver 124 configured to transmit reference signals (e.g., the CSI-RS). In some implementations, the channel access component 120 may optionally include a scheduler 126 configured to transmit a downlink transmission on the at least one beam during a COT. In some implementations, the channel access component 120 may optionally include an LBT component 128 configured to perform an LBT procedure prior to the PG.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (such as 51 interface), which may be wired or wireless. The base stations 102 configured for 5G NR (collectively referred to as Next Generation RAN (NG-RAN)) may interface with core network 190 through second backhaul links 184, which may be wired or wireless. In addition to other functions, the base stations 102 may perform one or more of the following functions: transfer of user data, radio channel ciphering and deciphering, integrity protection, header compression, mobility control functions (such as handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (such as through the EPC 160 or core network 190) with each other over third backhaul links 134 (such as X2 interface). The third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network also may include Home Evolved Node Bs (eNBs) (HeNBs), which may provide service to a restricted group known as a closed subscriber group (CSG). The communication links 112 between the base stations 102 and the UEs 104 may include UL (also referred to as reverse link) transmissions from a UE 104 to a base station 102 or DL (also referred to as forward link) transmissions from a base station 102 to a UE 104. The communication links 112 may use multiple-input and multiple-output (MIMO) antenna technology, including spatial multiplexing, beamforming, or transmit diversity. The communication links may be through one or more carriers. The base stations 102/UEs 104 may use spectrum up to Y MHz (such as 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (such as more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to or increase capacity of the access network.

A base station 102, whether a small cell 102′ or a large cell (such as macro base station), may include an eNB, gNodeB (gNB), or other type of base station. Some base stations, such as gNB 180 may operate in one or more frequency bands within the electromagnetic spectrum.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW radio frequency band have extremely high path loss and a short range. The mmW base station 180 may utilize beamforming 182 with the UE 104 to compensate for the path loss and short range.

The EPC 160 may include a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, or other IP services.

The base station may include or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (such as a MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (such as a parking meter, gas pump, toaster, vehicles, heart monitor, etc.). The UE 104 also may be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the following description may be focused on 5G NR, the concepts described herein may be applicable to other similar areas, such as LTE, LTE-A, CDMA, GSM, and other wireless technologies including future 6G technologies.

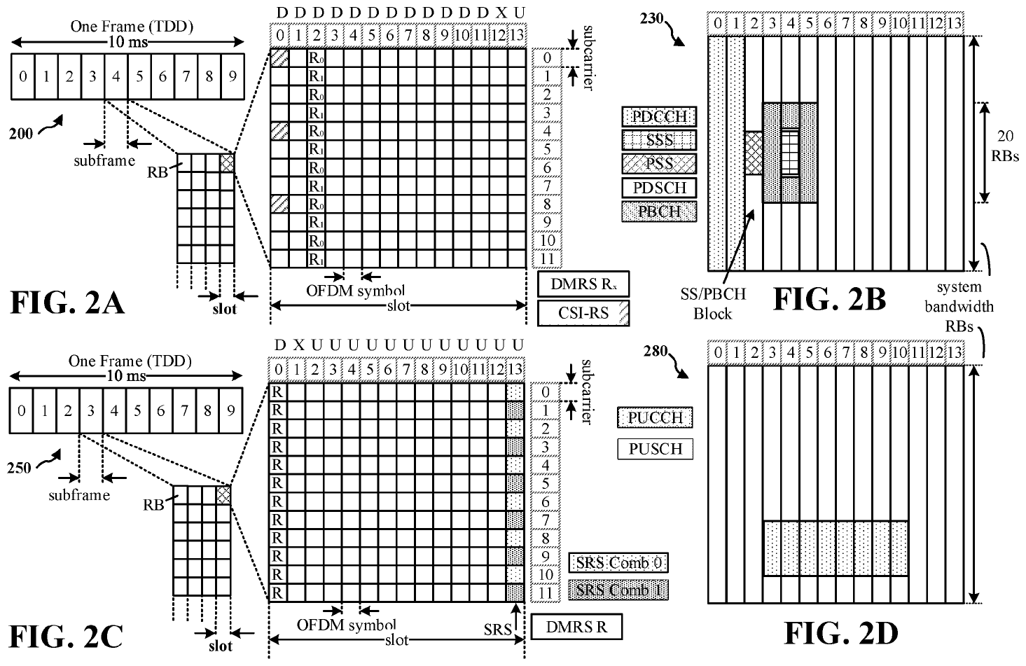

FIG. 2A is a diagram 200 illustrating an example of a first frame. FIG. 2B is a diagram 230 illustrating an example of DL channels within a subframe. FIG. 2C is a diagram 250 illustrating an example of a second frame. FIG. 2D is a diagram 280 illustrating an example of a subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure or different channels. A frame (10 milliseconds (ms)) may be divided into 10 equally sized subframes (1 ms). Each subframe may include one or more time slots. Subframes also may include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and Ti slots/subframe. The subcarrier spacing and symbol length/duration are a function of the numerology. The subcarrier spacing may be equal to 2^{μ}*15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 microseconds (μs).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS also may include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIGs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), or UCI.

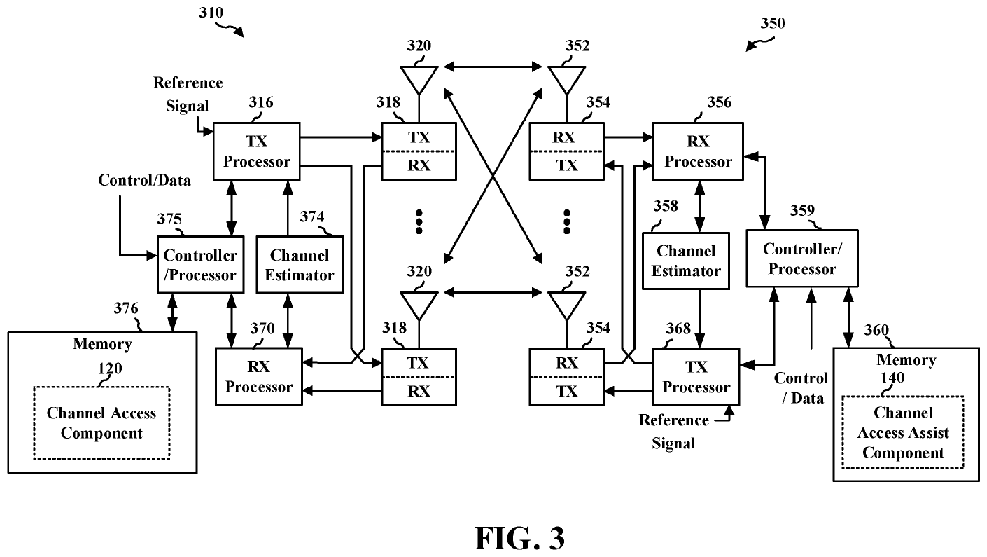

FIG. 3 is a diagram of an example of a base station 310 and a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (such as MIB, SIGs), RRC connection control (such as RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (such as binary phase-shift keying (BPSK), quadrature phase-shift keying (QPSK), M-phase-shift keying (M-PSK), M-quadrature amplitude modulation (M-QAM)). The coded and modulated symbols may be split into parallel streams. Each stream may be mapped to an OFDM subcarrier, multiplexed with a reference signal (such as a pilot) in the time or frequency domain, and combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal or channel condition feedback transmitted by the UE 350. Each spatial stream may be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are decoded and deinterleaved to recover the data and control signals that were originally transmitted by the base station 310 on the physical channel. The data and control signals are provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK or NACK protocol to support HARQ operations.

Similar to the functionality described in connection with the DL transmission by the base station 310, the controller/processor 359 provides RRC layer functionality associated with system information (such as MIB, SIBS) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK or NACK protocol to support HARQ operations.

At least one of the TX processor 368, the RX processor 356, and the controller/processor 359 may be configured to perform aspects in connection with channel access assist component 140 of FIG. 1.

At least one of the TX processor 316, the RX processor 370, and the controller/processor 375 may be configured to perform aspects in connection with the channel access component 120 of FIG. 1.

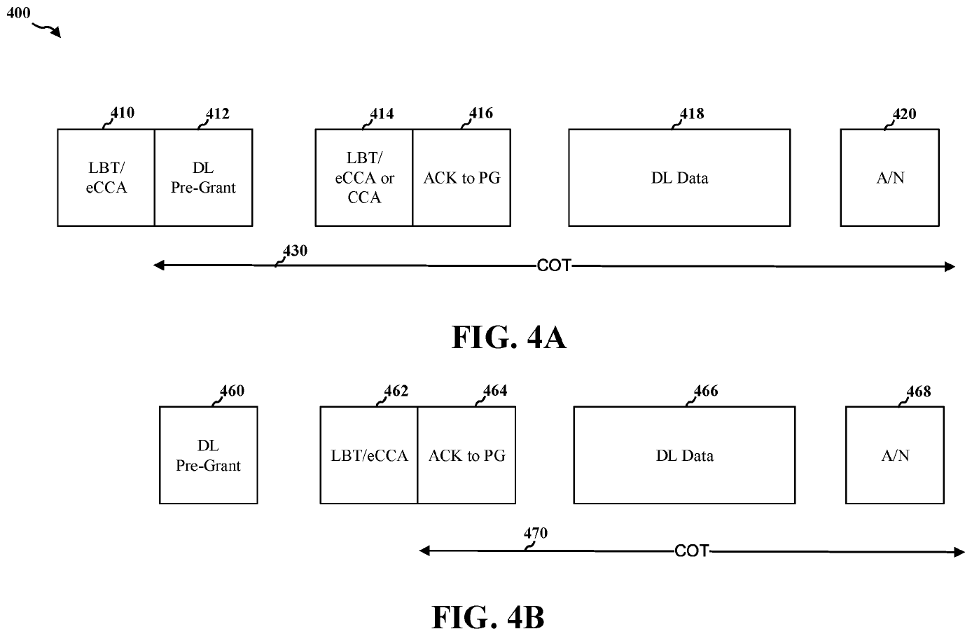

FIG. 4A is a diagram 400 illustrating example messages for a channel access procedure with LBT receiver assistance for a transmitter COT. The transmitter (e.g., a base station or gNB) may be the initiator and obtain a COT 430 with a category 4 LBT or eCCA procedure 410. The transmitter may then send a PG 412 requesting an LBT procedure 414 (e.g., Cat2 or Cat4) from the UE to confirm the good channel conditions if DL data is to be sent. If the channel passes the LBT at the UE, the UE may send a hard APG 416. The detection of the hard APG 416 at the transmitter confirms to the transmitter the possibility of sending downlink data 418 to the UE during the COT 430. The UE may transmit an ACK/NACK 420 based on the DL data 418.

FIG. 4B is a diagram illustrating example messages for a channel access procedure with LBT receiver assistance for a receiver COT. The transmitter may send the PG 460 under the short control signaling clause. The PG 460 may be a contention-exempt transmission or may be based on an optional Cat2 LBT. The PG 460 may request the UE to perform a Cat4 LBT 462 (e.g., an eCCA) to initiate a COT 470. The UE may share the COT 470 by sending a hard APG 464 back to the transmitter in case of success. The detection of the hard APG 464 at the transmitter confirms to the transmitter the possibility of sending downlink data 466 to the UE during the COT 470. The UE may transmit an ACK/NACK 468 based on the DL data 466.

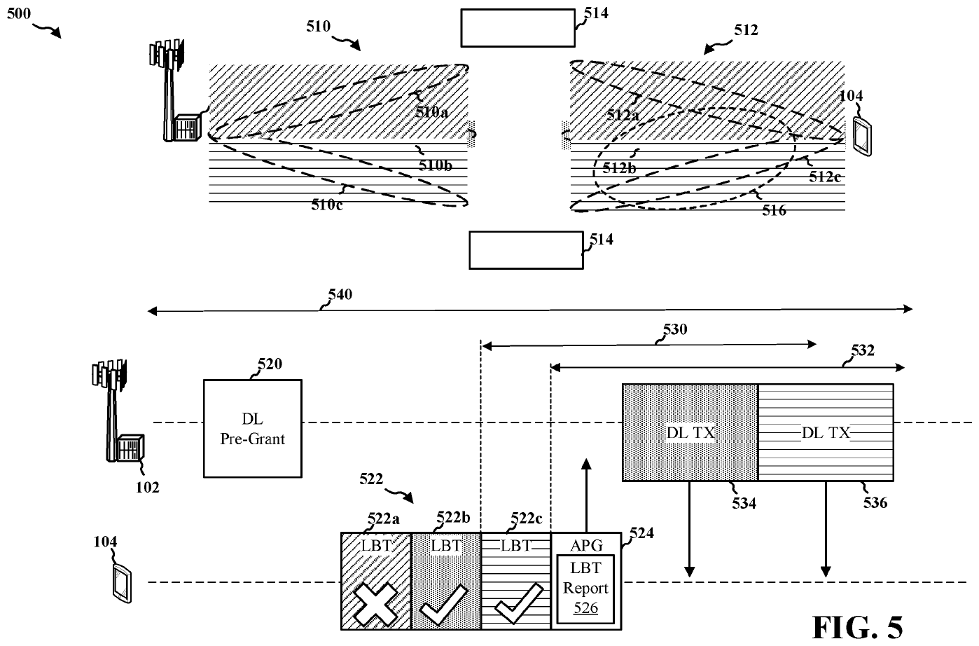

FIG. 5 is a diagram 500 illustrating example messages for a channel access procedure with LBT receiver assistance for multiple beams. The base station 102 and the UE 104 may communicate over different beams. For example, the base station may transmit using a transmit beam 510 and the UE 104 may receive via one or more of a plurality of receive beams 512. A receive beam 512 may correspond to a transmit beam 510. For example, the receive beam 512a may be the best receive beam 512 for receiving the transmit beam 510. For instance, the receive beam 512a may be directed toward an object 514 that reflects the transmit beam 510a. Similarly, the receive beam 512b may correspond to the transmit beam 510b and the receive beam 512c may correspond to the transmit beam 510c. As discussed above, when the base station 102 performs a LBT procedure in a frequency band where narrow beamforming is used, the channel sensing at the base station 102 may not detect interference that would be experienced by the UE 104. The interference may also vary significantly based on the receive beam of the UE 104.

In an implementation, the base station 102 may transmit a downlink PG 520. The PG 520 may indicate a plurality of beams 512 and a transmission resource. In an aspect, the PG 520 may be considered short control signaling and may be a contention-free transmission. In some implementations, there may be an existing COT (e.g., based on an LBT procedure performed by the base station 102).

The UE 104 may perform a multi-beam LBT procedure 522. In an implementation, the multi-beam LBT procedure 522 may include an LBT procedure on each of the plurality of beams. For instance, the UE 104 may perform an LBT procedure 522a on the receive beam 512a, an LBT procedure 522b on the receive beam 512b, and an LBT procedure 522c on the receive beam 512c. In an aspect, a channel access procedure with LBT receiver assistance for multiple beams may be based on either a transmitter COT or a receiver COT as discussed above with respect to FIGS. 4A and 4B. The LBT procedure 522 for each beam may be either long (e.g., category 4 LBT or eCCA) or short (e.g., category 2 LBT or CCA) depending on whether the UE 104 is to acquire a new receiver COT or an existing COT is to be used.

As illustrated, the multi-beam LBT procedure 522 may utilize time division multiplexing to perform the individual LBT procedures in sequence. In another implementation, the multi-beam LBT procedure may utilize space division multiplexing in which the individual LBT procedures are performed concurrently. In some implementations, the UE 104 may partition the plurality of beams 512 into one or more groups. For example, the UE 104 may group the beam 512b and 512c and perform an LBT procedure on a wider beam 516 that includes the beams 512b and 512c within an aperture of the wider beam 516. In the illustrated example, the LBT procedure 522a may fail (e.g., not complete within a time limit), but the LBT procedure 522b and 522c may be successful. Where the channel access procedure uses a receiver COT, a successful LBT procedure may start the receiver COT. For instance, the COT 530 may start at the end of the LBT procedure 522b and the COT 532 may start at the end of the LBT procedure 522c.

The UE 104 may transmit the APG 524 including an LBT report 526. The LBT report 526 may include a result for each of the LBT procedures 522. In some implementations, the LBT report 526 may include a timestamp of the end of each successful LBT procedure. Each receiver COT may be defined by the end of the respective LBT procedure 522 and a maximum channel occupancy time (MCOT) value (e.g., 5 ms). Accordingly, by transmitting the APG 524, the UE 104 may share one or more of the new receiver COTs 530 or 532 with the base station 102.

The COTs 530, 532 may allow the base station 102 to schedule a downlink transmission 534 or 536 during the COTs 530, 532. For example, the base station may transmit the downlink transmission 534 on the transmit beam 510b during the COT 530. The COT 530 may end before the COT 532. The base station 102 may transmit the downlink transmission 536 on the transmit beam 510c during the COT 532. In some implementations, the base station 102 may schedule a downlink transmission on fewer than the available COTs, or may schedule no downlink transmission on the available COTs.

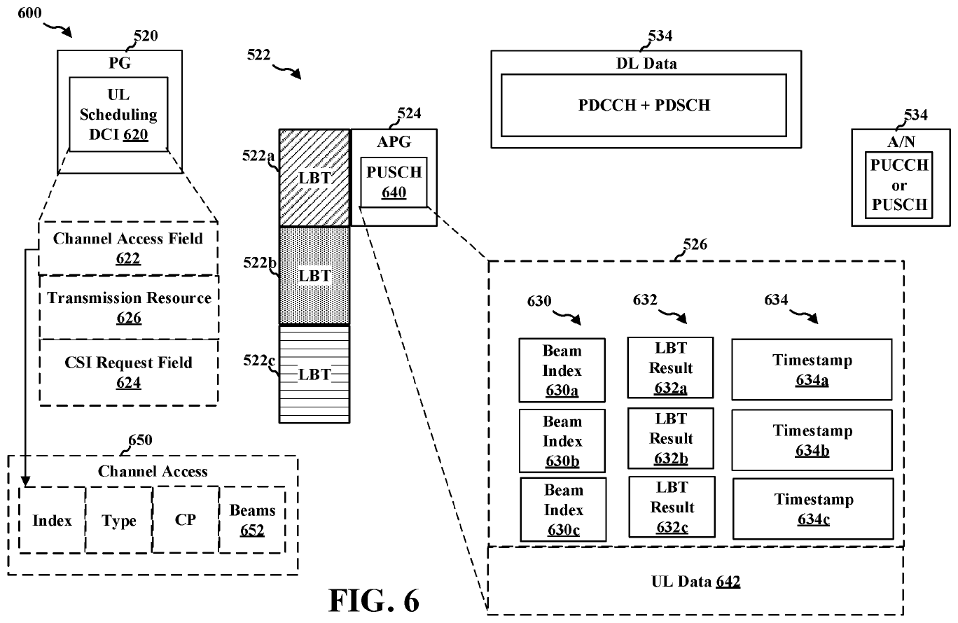

FIG. 6 is a diagram 600 illustrating example signaling of multiple beams for a channel access procedure with LBT receiver assistance. The channel access procedure may utilize 5G NR channels and messages for performing the channel access procedure. The PG 520 may transmitted as an UL scheduling DCI 620. For example the UL scheduling DCI 620 may follow DCI format 0_0. The UL scheduling DCI 620 may include a field that indicates a multi-beam LBT procedure. For example, the DCI 620 may include a channel access field 622 that identifies an entry or index in a configured channel access table 650. For instance, the channel access table 650 may be defined in a standards document or regulation. The channel access table 650 may be further configured via RRC signaling to include a set of beams 652 (e.g., a set of TCI state indices) identifying the plurality of beams. The channel access field 622 may identify an entry in the channel access table 650. Alternatively, a separate table may be defined in a standard or regulation or signaled via RRC. Reserved bits of the DCI 620 may define a new field that identifies an entry in the separate table. In another aspect, the DCI 620 may include a CSI request field 624 that indicates a CSI report configuration. The CSI report configuration may be configured (e.g., by RRC and/or MAC signaling) with a plurality of beams. Accordingly, the uplink scheduling DCI 620 may dynamically indicate the plurality of beams on which the UE 104 is to perform the LBT procedure 522. The uplink scheduling DCI 620 may also indicate a transmission resource 626. For example, the transmission resource 626 may be indicated by one or more resource allocation fields using dynamic scheduling. As another example, the uplink transmission may be based on a configured grant, and the DCI 620 may activate the configured grant. In some implementations, the transmission resource 626 may indicate a beam (e.g., a transmission configuration indication (TCI) state) for the uplink transmission.

In an aspect, as illustrated, the UE 104 may perform the LBT procedure 522 using space division multiplexing. That is, the UE 104 may perform the individual LBT procedures 522a, 522b, and 522c concurrently on the indicated beams. When the LBT procedure 522 is used to obtain a receiver COT, the use of space division multiplexing may result in multiple fully overlapping COTs. In another aspect, the indicated beams can be grouped to perform a single LBT on a wider beam. Each of the indicated beams may be within the aperture of the wider beam. If the LBT for the wider beam is successful, the beams within the group may be considered to have a successful LBT procedure.

The APG 524 may be transmitted as a physical uplink shared channel (PUSCH) 640. The PUSCH 640 may carry an LBT report 526. In an aspect, the LBT report 526 may be in the payload of the PUSCH 640 and may be decoded by the base station 102. Accordingly, scheduling based on the LBT report 526 may be associated with decoding delays. The LBT report 526 may include a beam index 630 (e.g., beam indices 630a, 630b, 630c), a LBT result 632 (e.g., LBT result 632a, 632b, 632c), and a timestamp 634 (e.g., timestamp 634a, 634b, 634c) for each of the plurality of beams. In some implementations where the PUSCH 640 is transmitted during a COT, the PUSCH 640 may include uplink data 642.

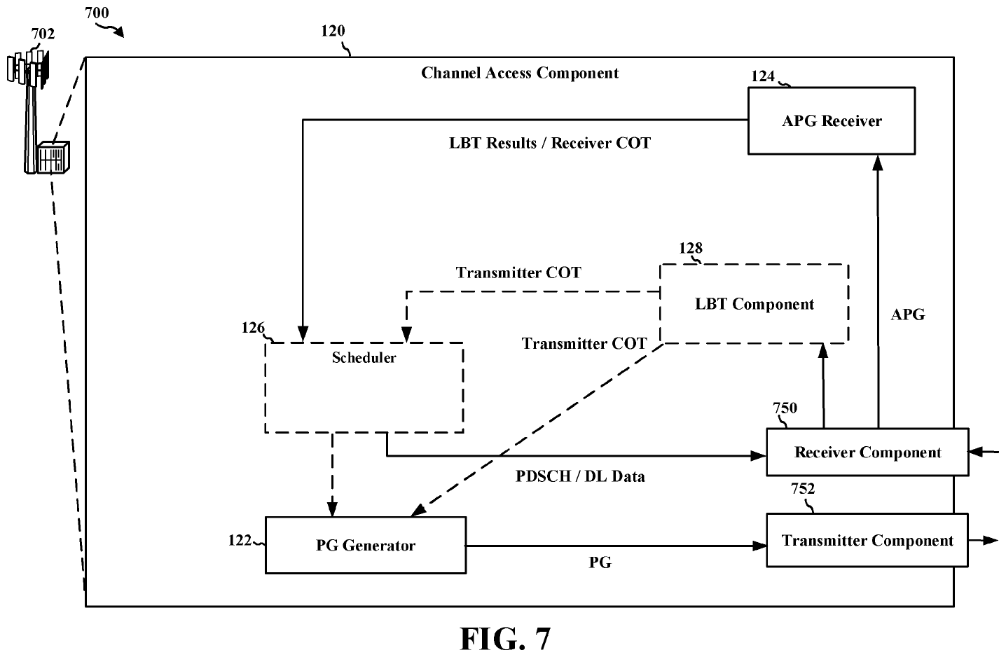

FIG. 7 is a conceptual data flow diagram 700 illustrating the data flow between different means/components in an example base station 702, which may be an example of the base station 102 including the channel access component 120. The channel access component 120 may be implemented by the memory 376 and the TX processor 316, the RX processor 370, and/or the controller/processor 375 of FIG. 3. For example, the memory 376 may store executable instructions defining the channel access component 120 and the TX processor 316, the RX processor 370, and/or the controller/processor 375 may execute the instructions.

The base station 102 may include a receiver component 750, which may include, for example, a radio frequency (RF) receiver for receiving the signals described herein. The base station 102 may include a transmitter component 752, which may include, for example, an RF transmitter for transmitting the signals described herein. In an aspect, the receiver component 750 and the transmitter component 752 may co-located in a transceiver such as illustrated by the TX/RX 318 in FIG. 3.

As discussed with respect to FIG. 1, the channel access component 120 may include the PG generator 122 and the APG receiver 124. The channel access component 120 may optionally include the scheduler 126 and/or the LBT component 128.

The PG generator 122 may be configured to transmit a PG 520 indicating a plurality of beams and a transmission resource to a UE 104 via the transmitter component 752. In some implementations, the PG generator 122 may receive an indication from the scheduler 126 that the base station 102 has downlink data to transmit to the UE 104. In some implementations, the PG generator 122 may receive an indication from the LBT component 128 indicating that the base station 102 has acquired a transmitter COT. In other implementations, the PG generator 122 may autonomously determine to transmit the PG 520. For example, the PG generator 122 may periodically transmit the PG 520 to have the UE 104 measure channel conditions. The PG generator 122 may determine the plurality of beams based on, for example, available beams indicated by the scheduler 126 and/or beams that have passed the transmitter LBT procedure and have a transmitter COT. Similarly, the PG generator 122 may determine the transmission resource based on available resources and/or a transmitter COT. In some implementations, the PG generator 122 may format the PG based on a DCI format (e.g., DCI format 0_0). For example, the PG generator 122 may set the channel access field 622 based on the determined plurality of beams and the configured channel access table 650 for the UE 104. For instance, the PG generator 122 may select a value of the channel access field 622 that indicates beams that match the determined beams. The PG generator 122 may transmit the PG 520 via the transmitter component 752. For example, the PG generator 122 may transmit the PG 520 on a PDCCH that the UE 104 is configured to monitor.

The receiver component 750 may receive UL signals from the UE 104 including the APG 524. The receiver component 750 may provide the APG 524 to the APG receiver 124. In some implementations, the receiver component 750 may sense a channel during an LBT procedure. The receiver component 750 may provide energy detected during the LBT procedure or a measurement thereof to the LBT component 128.

The APG receiver 124 may be configured to receive the APG 524 on the transmission resource. The APG 524 may include the LBT report 526 indicating a result of a LBT procedure 522 for each beam of the indicated plurality of beams. The APG receiver 124 may decode the APG 524 to extract the LBT report 526 and the information therein. In some implementations, the APG 524 is received as the PUSCH 640. The PUSCH 640 may be encoded based on a modulation and coding scheme (MCS) indicated by the UL scheduling DCI 620. The APG receiver 124 may decode the PUSCH 640 based on the MCS. The APG receiver 124 may extract the LBT report 526 from the decoded PUSCH 640. The APG receiver 124 may determine the beam index 630, LBT result 632, and timestamp 634 for each of the plurality of beams. In some implementations, the APG receiver may determine a receiver COT 530 and/or 532 based on the LBT report 526.

The APG receiver 124 may provide the beam information to the scheduler 126. The LBT component 128 may be configured to perform a base station LBT procedure. In some implementations, the LBT component 128 may perform the base station LBT procedure prior to the PG generator 122 transmitting the PG 520. The base station LBT procedure may be either a category 4 LBT procedure such as eCCA or a category 2 LBT procedure such as CCA. The LBT component 128 may control the receiver component 750 to sense one or more beams. The LBT component 128 may determine the energy detected on each beam and compare the energy detected to an energy detection threshold. If the LBT procedure is successful, the LBT component 128 may obtain a transmitter COT. The LBT component 128 may indicate the transmitter COT to the PG generator 122 and/or the scheduler 126.

The scheduler 126 may be configured to transmit a downlink transmission (e.g., DL data 534) on the at least one beam during a COT. The scheduler 126 may schedule the downlink transmission in response to the LBT report 526. For example, the scheduler 126 may select resources for the downlink transmission based on the LBT result 632 and timestamp 634 for each beam. In some implementations, the scheduler 126 may schedule a downlink transmission on each of the indicated plurality of beams with a successful LBT procedure.

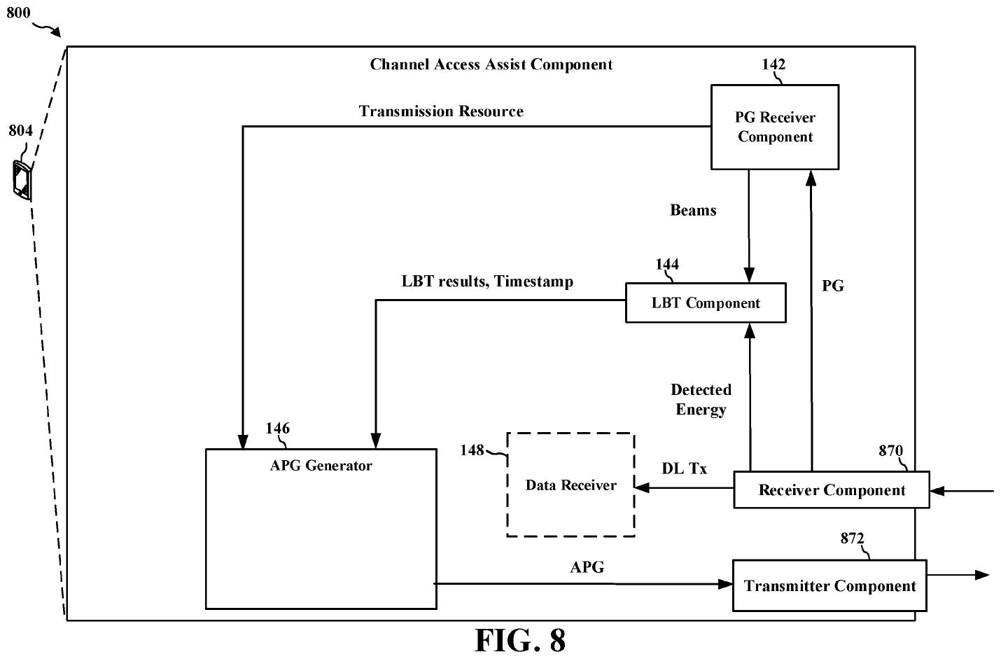

FIG. 8 is a conceptual data flow diagram 800 illustrating the data flow between different means/components in an example UE 804, which may be an example of the UE 104 and include the channel access assist component 140. The channel access assist component 140 may be implemented by the memory 360 and the TX processor 368, the RX processor 356, and/or the controller/processor 359. For example, the memory 360 may store executable instructions defining the channel access assist component 140 and the TX processor 368, the RX processor 356, and/or the controller/processor 359 may execute the instructions.

The UE 104 may include a receiver component 870, which may include, for example, a RF receiver for receiving the signals described herein. The UE 104 may include a transmitter component 872, which may include, for example, an RF transmitter for transmitting the signals described herein. In an aspect, the receiver component 870 and the transmitter component 872 may co-located in a transceiver such as the TX/RX 352 in FIG. 3.

As discussed with respect to FIG. 1, the channel access assist component 140 may include the PG receiver component 142, the LBT component 144, and the APG generator 146. The channel access assist component 140 may optionally include a data receiver 148.

The receiver component 870 may receive DL signals such as the PG 520 and the DL Tx 534 or 536. The receiver component 870 may provide the PG 520 to the PG receiver component 142. The receiver component 870 may provide the DL Tx 534 or 536 to the data receiver 148. The receiver component 870 may sense a channel during an LBT procedure 522. The receiver component 870 may provide energy detected during the LBT procedure or a measurement thereof to the LBT component 144.

The PG receiver component 142 may be configured to receive a PG 520 indicating a plurality of beams and a transmission resource. For example, the PG receiver component 142 may receive the PG 520 via the receiver component 870. In some implementations, the PG 520 may be an uplink scheduling DCI 620 that is received on a PDCCH. The PG receiver component 142 may perform blind decoding on PDCCH candidates in a configured CORESET to detect the PG 520. The PG receiver component 142 may decode the uplink scheduling DCI 620 based on a DCI format (e.g., DCI format 0_0) to determine the values of one or more fields. For example, the PG receiver component 142 may determine a value of a channel access field 622. The PG receiver component 142 may determine a CSI report configuration indicated by the channel access field 622. The PG receiver component 142 may determine the plurality of beams that are configured for the CSI report configuration. The PG receiver component 142 may provide the beams to the LBT component 144. The PG receiver component 142 may determine the transmission resource 626 based on, for example, one or more resource allocation fields. The PG receiver component 142 may provide the transmission resource 626 to the APG generator 146.

The LBT component 144 may be configured to perform a LBT procedure on each beam of the indicated plurality of beams. The LBT component 144 may receive an indication of the plurality of beams from the PG receiver component 142. The LBT component 144 may perform either a long LBT procedure or a short LBT procedure on each of the indicated plurality of beams. For example, the PG 520 may indicate which LBT procedure to select. The LBT component 144 may determine a counter based on the selected LBT procedure. The LBT component 144 may perform the LBT procedure 522 by controlling the receiver component 870 to measure detected energy on each of the plurality of beams (e.g., receive beams 512a, 512b, and 512c). The LBT component 144 may compare the detected energy to a detected energy threshold to determine whether to decrement the counter. The LBT component 144 may determine that the LBT procedure is successful when the counter reaches 0. The LBT component 144 may determine that the LBT procedure has failed when a time limit for the LBT procedure has been reached. The LBT component 144 may provide the LBT results for each beam to the APG generator 146. In cases where the LBT procedure results in a new receiver COT, the LBT component 144 may provide a timestamp of the end of the LBT procedure and start of the new receiver COT to the APG generator 146.

The APG generator 146 may be configured to transmit an APG 524 including a LBT report 526 for the indicated plurality of beams on the transmission resource. The LBT report 526 may indicate a result (e.g., LBT result 632) of the LBT procedure for each beam of the indicated plurality of beams. The APG generator 146 may receive the result of the LBT procedure from the LBT component 144. In some implementations, the APG generator 146 may receive a timestamp of the end of the LBT procedure from the LBT component 144. In some implementations, the APG generator 146 may generate the APG 524 as a PUSCH transmission, which may have a flexible format. In some cases, the PUSCH transmission may be a CSI report. The APG generator 146 may transmit the APG 524 via the transmitter component 872.

The data receiver 148 may be configured to receive a downlink transmission on at least one beam with a successful LBT procedure. For example, the data receiver 148 may control the receiver component 870 to monitor a CORESET for a DCI that schedules the downlink transmission during a COT for the at least one beam. The data receiver 148 may receive the downlink transmission during the COT based on the DCI. The data receiver 148 may provide the received data to higher layers. In some implementations, the data receiver 148 may provide an acknowledgment or negative acknowledgment of the downlink transmission to the transmitter component 872.

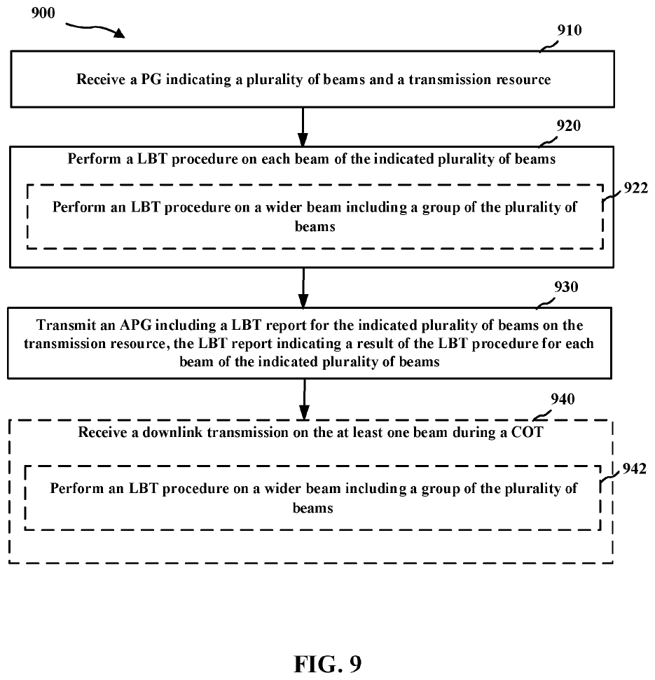

FIG. 9 is a flowchart of an example method 900 for a UE to perform multi-beam LBT to assist channel access. The method 900 may be performed by a UE (such as the UE 104, which may include the memory 360 and which may be the entire UE 104 or a component of the UE 104 such as the channel access assist component 140, TX processor 368, the RX processor 356, or the controller/processor 359). The method 900 may be performed by the channel access assist component 140 in communication with the channel access component 120 of the base station 102. Optional blocks are shown with dashed lines.

At block 910, the method 900 may include receiving a PG indicating a plurality of beams and a transmission resource. In some implementations, for example, the UE 104, the RX processor 356 or the controller/processor 359 may execute the channel access assist component 140 or the PG receiver component 142 to receive the PG 520 indicating a plurality of beams 512 and a transmission resource 626. In some implementations, the PG 520 is a DCI such as the uplink scheduling DCI 620. The uplink scheduling DCI 620 may dynamically schedule the APG 524 on the transmission resource 626 or activate a configured grant for the transmission resource 626. In some implementations, the uplink scheduling DCI 620 includes a field (e.g., channel access field 622) indicating activated beams based on a configured mapping of field values to sets of beams (e.g., channel access table 650). Accordingly, the UE 104, the RX processor 356, or the controller/processor 359 executing the channel access assist component 140 or the PG receiver component 142 may provide means for receiving a PG indicating a plurality of beams and a transmission resource.

At block 920, the method 900 may include performing a LBT procedure on each beam of the indicated plurality of beams. In some implementations, for example, the UE 104, the RX processor 356 or the controller/processor 359 may execute the channel access assist component 140 or the LBT component 144 to perform the LBT procedure 522 on each beam of the indicated plurality of beams 512. In some implementations, the LBT procedure is an eCCA procedure. In some implementations, the LBT procedure is a CCA procedure. In some implementations, the LBT procedure for each beam of the indicated plurality of beams is TDM as illustrated in FIG. 5. In some implementations, the LBT procedure for each beam of the indicated plurality of beams is SDM as illustrated in FIG. 6. In some implementations, at sub-block 922, the block 920 may include performing an LBT procedure on a wider beam including a group of the plurality of beams. Accordingly, the UE 104, the RX processor 356, or the controller/processor 359 executing the channel access assist component 140 or the LBT component 144 may provide means for performing a LBT procedure on each beam of the indicated plurality of beams.

At block 930, the method 900 may include transmitting an APG including a LBT report for the indicated plurality of beams on the transmission resource. The LBT report may indicate a result of the LBT procedure for each beam of the indicated plurality of beams. In some implementations, for example, the UE 104, the TX processor 368, or the controller/processor 359 may execute the channel access assist component 140 or the APG generator 146 to transmit the APG 524 including the LBT report 526 for the indicated plurality of beams on the transmission resource. The LBT report 526 may indicate a result of the LBT procedure (e.g., LBT result 632) for each beam of the indicated plurality of beams 512. In some implementations, the transmission resource corresponds to the at least one beam with the successful LBT procedure. In such cases, the APG 524 may include uplink data 642. In some implementations, the APG 524 includes a timestamp 634 of the successful LBT procedure. In some implementations, the LBT report 526 is a multi-beam CSI report. In some implementations, the APG is transmitted outside of a COT as a contention-free transmission. In such cases, the PG may indicate that only control signaling is allowed on the transmission resource. In some implementations where the LBT procedure is performed on a wider beam for a group of beams, the APG may include an indication of the LBT procedure for the group of the plurality of beams. In some implementations, the APG 524 is a PUSCH 640 scheduled by the PG 520. In view of the foregoing, the UE 104, the TX processor 368, or the controller/processor 359 executing the channel access assist component 140 or the APG generator 146 may provide means for transmitting an APG including a LBT report for the indicated plurality of beams on the transmission resource.

At block 940, the method 900 may optionally include receiving a downlink transmission on the at least one beam during a COT. For instance, the block 940 may be performed when the result for at least one beam of the indicated plurality of beams is a successful LBT procedure. In some implementations, for example, the UE 104, the RX processor 356 or the controller/processor 359 may execute the channel access assist component 140 or the data receiver 148 to receive the downlink transmission 534 or 536 on the at least one beam during a COT 530, 532, or 540. Where the LBT procedure is an eCCA procedure, the COT 530 or 532 may be defined by an end of the successful LBT procedure 522b or 522c corresponding to the at least one beam and a MCOT value. In other implementations, the COT 540 is defined by an end of an LBT procedure performed prior to the PG and the MCOT value. In some implementations, in block 942, the block 940 may optionally include receiving the downlink transmission 534 and 536 on each of the at least one beam with the successful LBT procedure (e.g., beams 512b and 512c). Accordingly, the UE 104, the RX processor 356, or the controller/processor 359 executing the channel access assist component 140 or the data receiver 148 may provide means for receiving a downlink transmission on the at least one beam during a COT.

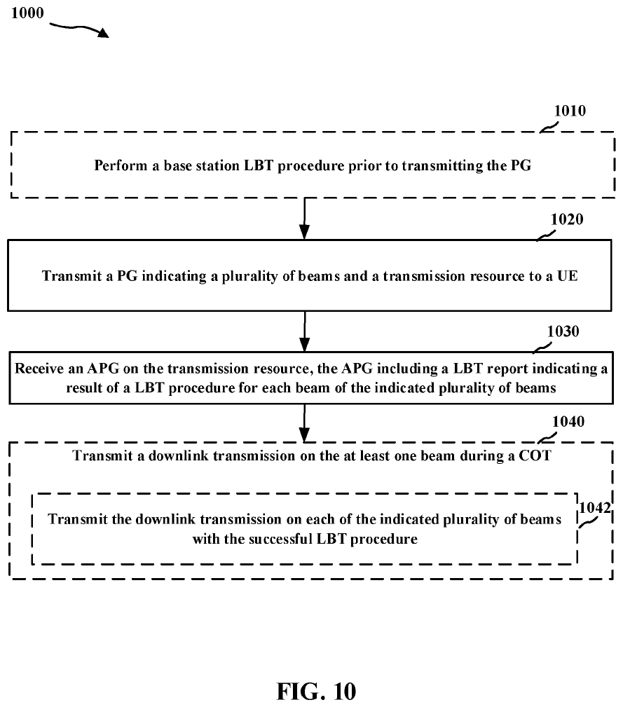

FIG. 10 is a flowchart of an example method 1000 for a base station to access a channel with multi-beam LBT assistance from a UE. The method 1000 may be performed by a base station (such as the base station 102, which may include the memory 376 and which may be the entire base station 102 or a component of the base station 102 such as the channel access component 120, the TX processor 316, the RX processor 370, or the controller/processor 375). The method 1000 may be performed by the channel access component 120 in communication with the channel access assist component 140 of the UE 104.

At block 1010, the method 1000 may optionally include performing a base station LBT procedure prior to transmitting the PG. In some implementations, for example, the base station 102, the RX processor 370, or the controller/processor 375 may execute the channel access component 120 or the LBT component 128 to perform a base station LBT procedure prior to transmitting the PG. The base station LBT procedure may be used to obtain a transmitter COT 540. Accordingly, the base station 102, the RX processor 370, or the controller/processor 375 executing the channel access component 120 or the LBT component 128 may provide means for performing a base station LBT procedure prior to transmitting the PG.

At block 1020, the method 1000 may include transmitting a PG indicating a plurality of beams and a transmission resource to a UE. In some implementations, for example, base station 102, the TX processor 316, or the controller/processor 375 may execute the channel access component 120 or the PG generator 122 to transmit the PG 520 indicating the plurality of beams 512 and the transmission resource 626 to the UE 104. In some implementations, the PG 520 is a DCI such as an uplink scheduling DCI 620. The DCI 620 may dynamically schedule the APG 524 on the transmission resource 626 or activate a configured grant for the transmission resource 626. The DCI 620 may include a field (e.g., channel access field 622) indicating the plurality of beams based on a configured mapping of field values to sets of beams (e.g., channel access table 650). Accordingly, the base station 102, the TX processor 316, or the controller/processor 375 executing the channel access component 120 or the PG generator 122 may provide means for transmitting a PG indicating a plurality of beams and a transmission resource to a UE.

At block 1030, the method 1000 may include receiving an APG on the transmission resource, the APG including a LBT report indicating a result of a LBT procedure for each beam of the indicated plurality of beams. In some implementations, for example, the base station 102, the RX processor 370, or the controller/processor 375 may execute the channel access component 120 or the APG receiver 124 to receive the APG 524 on the transmission resource 626. The APG 524 may include a LBT report 526 indicating a result of a LBT procedure (e.g., LBT result 632) for each beam of the indicated plurality of beams. In some implementations, the LBT procedure is an eCCA procedure. In some implementations, the transmission resource corresponds to the at least one beam corresponding to the successful LBT procedure. A receiver COT 530, 532 may be defined by an end of the successful eCCA procedure corresponding to the at least one beam and a MCOT value. In some implementations, the APG 524 includes a timestamp 634 of the successful LBT procedure. In some implementations, where the base station LBT procedure is performed in block 1010, the LBT procedure is a CCA procedure. In some implementations, the APG 524 is received outside of a COT as a contention-free transmission. In such cases, the PG 520 indicates that uplink data is not allowed on the transmission resource. In some implementations, the APG 524 is a PUSCH 640 scheduled by the PG 520. In some implementations, the LBT report 526 is a multi-beam CSI report. In view of the foregoing, the base station 102, the RX processor 370, or the controller/processor 375 executing the channel access component 120 or the LBT component 128 may provide means for receiving an APG on the transmission resource, the APG including a LBT report indicating a result of a LBT procedure for each beam of the indicated plurality of beams.

At block 1040, the method 1000 may optionally include transmitting a downlink transmission on the at least one beam during a COT. For example, the block 1040 may be performed when the result for at least one beam of the indicated plurality of beams is a successful LBT procedure. In some implementations, for example, base station 102, the TX processor 316, or the controller/processor 375 may execute the channel access component 120 or the scheduler 126 to transmit the downlink transmission (e.g., DL data 534 or 536) on the at least one beam during a COT. In some implementations, at sub-block 1042, the block 1040 may optionally include transmitting the downlink transmission on each of the indicated plurality of beams with the successful LBT procedure. Accordingly, the base station 102, the TX processor 316, or the controller/processor 375 executing the channel access component 120 or the PG generator 122 may provide means for transmitting a downlink transmission on the at least one beam during a COT.

### Some Further Example Clauses

Implementation examples are described in the following numbered clauses:
1. A method of wireless communication, comprising, at a user equipment (UE):
   receiving a pre-grant (PG) indicating a plurality of beams and a transmission resource;
   performing a listen before talk (LBT) procedure on each beam of the indicated plurality of beams; and
   transmitting an acknowledgment to the pre-grant (APG) including a LBT report for the indicated plurality of beams on the transmission resource, the LBT report indicating a result of the LBT procedure for each beam of the indicated plurality of beams.
2. The method of clause 1, wherein the result for at least one beam of the indicated plurality of beams is a successful LBT procedure, and wherein a transmitter is allowed to transmit a downlink transmission on the at least one beam during a channel occupancy time (COT).
3. The method of clause 2, further comprising receiving the downlink transmission on the at least one beam with the successful LBT procedure.
4. The method of clause 2 or 3, wherein the LBT procedure is an extended clear channel assessment (eCCA) procedure.
5. The method of clause 4, wherein the COT is defined by an end of the successful LBT procedure corresponding to the at least one beam and a maximum channel occupancy time (MCOT) value.
6. The method of clause 4 or 5, wherein the transmission resource corresponds to the at least one beam with the successful LBT procedure.
7. The method of any of clauses 4-6, wherein the APG includes a timestamp of the successful LBT procedure.
8. The method of clause 2 or 3, wherein the LBT procedure is a short clear channel assessment (CCA) procedure.
9. The method of any of clauses 1-8, wherein the APG is transmitted on a COT is defined by an end of an LBT procedure performed prior to the PG and a maximum channel occupancy time (MCOT) value.
10. The method of any of clauses 1-8, wherein the APG is transmitted outside of a channel occupancy time (COT) as a contention-free transmission.
11. The method of clause 10, wherein the PG indicates that only control signaling is allowed on the transmission resource.
12. The method of any of clauses 1-11, wherein the APG is a physical uplink shared channel (PUSCH) scheduled by the PG.
13. The method of any of clauses 1-11, wherein the PG is a downlink control information (DCI).
14. The method of clause 13, wherein the DCI dynamically schedules the APG on the transmission resource or activates a configured grant for the transmission resource.
15. The method of clause 13 or 14, wherein the DCI includes a field indicating activated beams based on a configured mapping of field values to sets of beams.
16. The method of any of clauses 1-15, wherein the LBT report is a multi-beam channel state information (CSI) report.
17. The method of any of clauses 1-16, wherein the LBT procedure for each beam of the indicated plurality of beams is time division multiplexed (TDM).
18. The method any of clauses 1-16, wherein the LBT procedure for each beam of the indicated plurality of beams is space division multiplexed (SDM).
19. The method of any of clauses 1-16, wherein performing the LBT procedure for each beam of the indicated plurality of beams comprises performing an LBT procedure on a wider beam including a group of the plurality of beams.
20. The method of clause 19, wherein the LBT report includes an indication of a result of the LBT procedure for the group of the plurality of beams.
21. A method of wireless communication, comprising, at a base station:
   transmitting a pre-grant (PG) indicating a plurality of beams and a transmission resource to a user equipment (UE); and
   receiving an acknowledgment to the pre-grant (APG) on the transmission resource, the APG including a listen before talk (LBT) report indicating a result of a LBT procedure for each beam of the indicated plurality of beams.
22. The method of clause 21, wherein the result for at least one beam of the indicated plurality of beams is a successful LBT procedure, and wherein the base station is allowed to transmit a downlink transmission on the at least one beam during a channel occupancy time (COT).
23. The method of clause 22, further comprising transmitting a downlink transmission on the at least one beam during the COT.
24. The method of clause 22 or 23, wherein the LBT procedure is an extended clear channel assessment (eCCA) procedure.
25. The method of clause 24, wherein the COT is defined by an end of the successful LBT procedure corresponding to the at least one beam and a maximum channel occupancy time (MCOT) value.
26. The method of clause 24 or 25, wherein the transmission resource corresponds to the at least one beam corresponding to the successful LBT procedure.
27. The method of any of clauses 24-26, wherein the APG includes a timestamp of the successful LBT procedure.
28. The method of clause 22 or 23, wherein the LBT procedure is a short clear channel assessment (CCA) procedure.
29. The method of any of clauses 21-28, further comprising performing a base station LBT procedure prior to transmitting the PG, wherein the APG is received on a COT defined by an end of the base station LBT procedure and a maximum channel occupancy time (MCOT) value.
30. The method of any of clauses 21-28, wherein the APG is received outside of a channel occupancy time (COT) as a contention-free transmission.
31. The method of clause 30, wherein the PG indicates that uplink data is not allowed on the transmission resource.
32. The method of any of clauses 21-31, wherein the APG is a physical uplink shared channel (PUSCH) scheduled by the PG.
33. The method of any of clauses 21-31, wherein the PG is a downlink control information (DCI).
34. The method of clause 33, wherein the DCI dynamically schedules the APG on the transmission resource or activates a configured grant for the transmission resource.
35. The method of clause 33 or 34, wherein the DCI includes a field indicating the plurality of beams based on a configured mapping of field values to sets of beams.
36. The method of any of clauses 21-35, wherein the LBT report is a multi-beam channel state information (CSI) report.
37. The method of any of clauses 21-31, wherein the LBT procedure for each of the indicated plurality of beams is time division multiplexed (TDM).
38. The method of any of clauses 21-31, wherein the LBT procedure for each of the indicated plurality of beams is space division multiplexed (SDM).
39. The method of any of clauses 21-31, wherein the LBT procedure for each of the indicated plurality of beams is performed on a wider beam including a group of the plurality of beams.
40. The method of clause 39, wherein the report includes an indication of a result of the LBT procedure for the group of the plurality of beams.
41. An apparatus for wireless communication at a user equipment (UE), comprising:
   a memory storing computer-executable instructions; and
   at least one processor coupled to the memory and configured to execute the instructions to:
      receive a pre-grant (PG) indicating a plurality of beams and a transmission resource;
      perform a listen before talk (LBT) procedure on each beam of the indicated plurality of beams; and
      transmit an acknowledgment to the pre-grant (APG) including a LBT report for the indicated plurality of beams on the transmission resource, the LBT report indicating a result of the LBT procedure for each beam of the indicated plurality of beams.
42. The apparatus of clause 41, wherein the result for at least one beam of the indicated plurality of beams is a successful LBT procedure, and wherein a transmitter is allowed to transmit a downlink transmission on the at least one beam during a channel occupancy time (COT).
43. The apparatus of clause 42, wherein the at least one processor is configured to receive the downlink transmission on the at least one beam with the successful LBT procedure.
44. The apparatus of clause 42 or 43, wherein the LBT procedure is an extended clear channel assessment (eCCA) procedure.
45. The apparatus of clause 44, wherein the COT is defined by an end of the successful LBT procedure corresponding to the at least one beam and a maximum channel occupancy time (MCOT) value.
46. The apparatus of clause 44 or 45, wherein the transmission resource corresponds to the at least one beam with the successful LBT procedure.
47. The apparatus of any of clauses 44-46, wherein the APG includes a timestamp of the successful LBT procedure.
48. The apparatus of clause 42 or 43, wherein the LBT procedure is a short clear channel assessment (CCA) procedure.
49. The apparatus of any of clauses 41-48, wherein the APG is transmitted on a COT is defined by an end of an LBT procedure performed prior to the PG and a maximum channel occupancy time (MCOT) value.
50. The apparatus any of clauses 41-48, wherein the APG is transmitted outside of a channel occupancy time (COT) as a contention-free transmission.
51. The apparatus of clause 50, wherein the PG indicates that only control signaling is allowed on the transmission resource.
52. The apparatus of any of clauses 41-51, wherein the APG is a physical uplink shared channel (PUSCH) scheduled by the PG.
53. The apparatus any of clauses 41-51, wherein the PG is a downlink control information (DCI).
54. The apparatus of clause 53, wherein the DCI dynamically schedules the APG on the transmission resource or activates a configured grant for the transmission resource.
55. The apparatus of clause 53 or 54, wherein the DCI includes a field indicating activated beams based on a configured mapping of field values to sets of beams.
56. The apparatus of any of clauses 41-55, wherein the LBT report is a multi-beam channel state information (CSI) report.
57. The apparatus of any of clauses 41-56, wherein the LBT procedure for each beam of the indicated plurality of beams is time division multiplexed (TDM).
58. The apparatus of any of clauses 41-56, wherein the LBT procedure for each beam of the indicated plurality of beams is space division multiplexed (SDM).
59. The apparatus of any of clauses 41-56, wherein the at least one processor is configured to perform an LBT procedure on a wider beam including a group of the plurality of beams.
60. The apparatus of clause 59, wherein the LBT report includes an indication of a result of the LBT procedure for the group of the plurality of beams.
61. An apparatus for wireless communication at a base station, comprising:
   a memory storing computer-executable instructions; and
   at least one processor coupled to the memory and configured to execute the instructions to:
      transmit a pre-grant (PG) indicating a plurality of beams and a transmission resource to a user equipment (UE); and
      receive an acknowledgment to the pre-grant (APG) on the transmission resource, the APG including a listen before talk (LBT) report indicating a result of a LBT procedure for each beam of the indicated plurality of beams.
62. The apparatus of clause 61, wherein the result for at least one beam of the indicated plurality of beams is a successful LBT procedure, and wherein the base station is allowed to transmit a downlink transmission on the at least one beam during a channel occupancy time (COT).
63. The apparatus of clause 62, wherein the at least one processor is configured to transmit a downlink transmission on the at least one beam during the COT.
64. The apparatus of clause 62 or 63, wherein the LBT procedure is an extended clear channel assessment (eCCA) procedure.
65. The apparatus of clause 64, wherein the COT is defined by an end of the successful LBT procedure corresponding to the at least one beam and a maximum channel occupancy time (MCOT) value.
66. The apparatus of clause 64 or 65, wherein the transmission resource corresponds to the at least one beam corresponding to the successful LBT procedure.
67. The apparatus of any of clauses 64-67, wherein the APG includes a timestamp of the successful LBT procedure.
68. The apparatus of clause 62 or 63, wherein the LBT procedure is a short clear channel assessment (CCA) procedure.
69. The apparatus of any of clauses 61-68, wherein the at least one processor is configured to perform a base station LBT procedure prior to transmitting the PG, wherein the APG is received on a COT defined by an end of the base station LBT procedure and a maximum channel occupancy time (MCOT) value.
70. The apparatus of any of clauses 61-68, wherein the APG is received outside of a channel occupancy time (COT) as a contention-free transmission.
71. The apparatus of clause 70, wherein the PG indicates that uplink data is not allowed on the transmission resource.
72. The apparatus of any of clauses 61-71, wherein the APG is a physical uplink shared channel (PUSCH) scheduled by the PG.
73. The apparatus of any of clauses 61-72, wherein the PG is a downlink control information (DCI).
74. The apparatus of clause 73, wherein the DCI dynamically schedules the APG on the transmission resource or activates a configured grant for the transmission resource.
75. The apparatus of clause 73 or 74, wherein the DCI includes a field indicating the plurality of beams based on a configured mapping of field values to sets of beams.
76. The apparatus of any of clauses 61-75, wherein the LBT report is a multi-beam channel state information (CSI) report.
77. The apparatus of any of clauses 61-76, wherein the LBT procedure for each of the indicated plurality of beams is time division multiplexed (TDM).
78. The apparatus of any of clauses 61-76, wherein the LBT procedure for each of the indicated plurality of beams is space division multiplexed (SDM).
79. The apparatus of any of clauses 61-76, wherein the LBT procedure for each of the indicated plurality of beams is performed on a wider beam including a group of the plurality of beams.
80. The apparatus of clause 79, wherein the report includes an indication of a result of the LBT procedure for the group of the plurality of beams.
81. An apparatus for wireless communication at a user equipment (UE), comprising:
   means for receiving a pre-grant (PG) indicating a plurality of beams and a transmission resource;
   means for performing a listen before talk (LBT) procedure on each beam of the indicated plurality of beams; and
   means for transmitting an acknowledgment to the pre-grant (APG) including a LBT report for the indicated plurality of beams on the transmission resource, the LBT report indicating a result of the LBT procedure for each beam of the indicated plurality of beams.
82. The apparatus of clause 81, wherein the result for at least one beam of the indicated plurality of beams is a successful LBT procedure, and wherein a transmitter is allowed to transmit a downlink transmission on the at least one beam during a channel occupancy time (COT).
83. The apparatus of clause 82, further comprising means for receiving the downlink transmission on the at least one beam with the successful LBT procedure.
84. The apparatus of clause 82 or 83, wherein the LBT procedure is an extended clear channel assessment (eCCA) procedure.
85. The apparatus of clause 84, wherein the COT is defined by an end of the successful LBT procedure corresponding to the at least one beam and a maximum channel occupancy time (MCOT) value.
86. The apparatus of clause 84 or 85, wherein the transmission resource corresponds to the at least one beam with the successful LBT procedure.
87. The apparatus of any of clauses 84-86, wherein the APG includes a timestamp of the successful LBT procedure.
88. The apparatus of clause 82 or 83, wherein the LBT procedure is a short clear channel assessment (CCA) procedure.
89. The apparatus of any of clauses 81-88, wherein the APG is transmitted on a COT defined by an end of an LBT procedure performed prior to the PG and a maximum channel occupancy time (MCOT) value.
90. The apparatus of any of clauses 81-88, wherein the APG is transmitted outside of a channel occupancy time (COT) as a contention-free transmission.
91. The apparatus of clause 90, wherein the PG indicates that only control signaling is allowed on the transmission resource.
92. The apparatus of any of clauses 81-91, wherein the APG is a physical uplink shared channel (PUSCH) scheduled by the PG.
93. The apparatus of any of clauses 81-91, wherein the PG is a downlink control information (DCI).
94. The apparatus of clause 93, wherein the DCI dynamically schedules the APG on the transmission resource or activates a configured grant for the transmission resource.
95. The apparatus of clause 93 or 94, wherein the DCI includes a field indicating activated beams based on a configured mapping of field values to sets of beams.
96. The apparatus of any of clauses 81-95, wherein the LBT report is a multi-beam channel state information (CSI) report.
97. The apparatus of any of clauses 81-96, wherein the LBT procedure for each beam of the indicated plurality of beams is time division multiplexed (TDM).
98. The apparatus of any of clauses 81-96, wherein the LBT procedure for each beam of the indicated plurality of beams is space division multiplexed (SDM).
99. The apparatus of any of clauses 81-96, wherein the means for performing the LBT procedure for each beam of the indicated plurality of beams is configured to perform an LBT procedure on a wider beam including a group of the plurality of beams.
100. The apparatus of clause 99, wherein the LBT report includes an indication of a result of the LBT procedure for the group of the plurality of beams.
101. An apparatus for wireless communication at a base station, comprising:
   means for transmitting a pre-grant (PG) indicating a plurality of beams and a transmission resource to a user equipment (UE); and
   means for receiving an acknowledgment to the pre-grant (APG) on the transmission resource, the APG including a listen before talk (LBT) report indicating a result of a LBT procedure for each beam of the indicated plurality of beams.
102. The apparatus of clause 101, wherein the result for at least one beam of the indicated plurality of beams is a successful LBT procedure, and wherein the base station is allowed to transmit a downlink transmission on the at least one beam during a channel occupancy time (COT).
103. The apparatus of clause 102, further comprising means for transmitting a downlink transmission on the at least one beam during the COT.
104. The apparatus of clause 102 or 103, wherein the LBT procedure is an extended clear channel assessment (eCCA) procedure.
105. The apparatus of clause 104, wherein the COT is defined by an end of the successful LBT procedure corresponding to the at least one beam and a maximum channel occupancy time (MCOT) value.
106. The apparatus of clause 104 or 105, wherein the transmission resource corresponds to the at least one beam corresponding to the successful LBT procedure.
107. The apparatus of any of clauses 104-106, wherein the APG includes a timestamp of the successful LBT procedure.
108. The apparatus of clause 102 or 103, wherein the LBT procedure is a short clear channel assessment (CCA) procedure.
109. The apparatus of any of clauses 101-108, further comprising means for performing a base station LBT procedure prior to transmitting the PG, wherein the APG is received on a COT defined by an end of the base station LBT procedure and a maximum channel occupancy time (MCOT) value.
110. The apparatus of any of clauses 101-108, wherein the APG is received outside of a channel occupancy time (COT) as a contention-free transmission.
111. The apparatus of clause 110, wherein the PG indicates that uplink data is not allowed on the transmission resource.
112. The apparatus of any of clauses 101-111, wherein the APG is a physical uplink shared channel (PUSCH) scheduled by the PG.
113. The apparatus of any of clauses 101-112, wherein the PG is a downlink control information (DCI).
114. The apparatus of clause 113, wherein the DCI dynamically schedules the APG on the transmission resource or activates a configured grant for the transmission resource.
115. The apparatus of clause 113 or 114, wherein the DCI includes a field indicating the plurality of beams based on a configured mapping of field values to sets of beams.
116. The apparatus of any of clauses 101-115, wherein the LBT report is a multi-beam channel state information (CSI) report.
117. The apparatus of any of clauses 101-116, wherein the LBT procedure for each of the indicated plurality of beams is time division multiplexed (TDM).
118. The apparatus of any of clauses 101-116, wherein the LBT procedure for each of the indicated plurality of beams is space division multiplexed (SDM).
119. The apparatus of any of clauses 101-116, wherein the LBT procedure for each of the indicated plurality of beams is performed on a wider beam including a group of the plurality of beams.
120. The apparatus of clause 119, wherein the report includes an indication of a result of the LBT procedure for the group of the plurality of beams.
121. A non-transitory computer-readable medium storing computer executable code, the code when executed by a processor of a user equipment (UE) instructs the processor to:
   receive a pre-grant (PG) indicating a plurality of beams and a transmission resource;
   perform a listen before talk (LBT) procedure on each beam of the indicated plurality of beams; and
   transmit an acknowledgment to the pre-grant (APG) including a LBT report for the indicated plurality of beams on the transmission resource, the LBT report indicating a result of the LBT procedure for each beam of the indicated plurality of beams.
122. The non-transitory computer-readable medium of clause 121, wherein the result for at least one beam of the indicated plurality of beams is a successful LBT procedure, and wherein a transmitter is allowed to transmit a downlink transmission on the at least one beam during a channel occupancy time (COT).
123. The non-transitory computer-readable medium of clause 122, further comprising code to receive the downlink transmission on the at least one beam with the successful LBT procedure.
124. The non-transitory computer-readable medium of clause 122 or 123, wherein the LBT procedure is an extended clear channel assessment (eCCA) procedure.
125. The non-transitory computer-readable medium of clause 124, wherein the COT is defined by an end of the successful LBT procedure corresponding to the at least one beam and a maximum channel occupancy time (MCOT) value.
126. The non-transitory computer-readable medium of clause 124 or 125, wherein the transmission resource corresponds to the at least one beam with the successful LBT procedure.
127. The non-transitory computer-readable medium of any of clauses 124-126, wherein the APG includes a timestamp of the successful LBT procedure.
128. The non-transitory computer-readable medium of clause 122 or 123, wherein the LBT procedure is a short clear channel assessment (CCA) procedure.
129. The non-transitory computer-readable medium of any of clauses 121-128, wherein the APG is transmitted on a COT is defined by an end of an LBT procedure performed prior to the PG and a maximum channel occupancy time (MCOT) value.
130. The non-transitory computer-readable medium of any of clauses 121-128, wherein the APG is transmitted outside of a channel occupancy time (COT) as a contention-free transmission.
131. The non-transitory computer-readable medium of clause 130, wherein the PG indicates that only control signaling is allowed on the transmission resource.
132. The non-transitory computer-readable medium of any of clauses 121-131, wherein the APG is a physical uplink shared channel (PUSCH) scheduled by the PG.
133. The non-transitory computer-readable medium of any of clauses 121-132, wherein the PG is a downlink control information (DCI).
134. The non-transitory computer-readable medium of clause 133, wherein the DCI dynamically schedules the APG on the transmission resource or activates a configured grant for the transmission resource.
135. The non-transitory computer-readable medium of clause 133 or 134, wherein the DCI includes a field indicating activated beams based on a configured mapping of field values to sets of beams.
136. The non-transitory computer-readable medium of any of clauses 133-135, wherein the LBT report is a multi-beam channel state information (CSI) report.
137. The non-transitory computer-readable medium of any of clauses 121-136, wherein the LBT procedure for each beam of the indicated plurality of beams is time division multiplexed (TDM).
138. The non-transitory computer-readable medium of any of clauses 121-136, wherein the LBT procedure for each beam of the indicated plurality of beams is space division multiplexed (SDM).
139. The non-transitory computer-readable medium of any of clauses 121-136, wherein the code to perform the LBT procedure for each beam of the indicated plurality of beams comprises code to perform an LBT procedure on a wider beam including a group of the plurality of beams.
140. The non-transitory computer-readable medium of clause 139, wherein the LBT report includes an indication of a result of the LBT procedure for the group of the plurality of beams.
141. A non-transitory computer-readable medium storing computer executable code, the code when executed by a processor of a base station instructs the processor to:
   transmit a pre-grant (PG) indicating a plurality of beams and a transmission resource to a user equipment (UE); and
   receive an acknowledgment to the pre-grant (APG) on the transmission resource, the APG including a listen before talk (LBT) report indicating a result of a LBT procedure for each beam of the indicated plurality of beams.
142. The non-transitory computer-readable medium of clause 141, wherein the result for at least one beam of the indicated plurality of beams is a successful LBT procedure, and wherein the base station is allowed to transmit a downlink transmission on the at least one beam during a channel occupancy time (COT).
143. The non-transitory computer-readable medium of clause 142, further comprising code to transmit a downlink transmission on the at least one beam during the COT.
144. The non-transitory computer-readable medium of clause 142 or 143, wherein the LBT procedure is an extended clear channel assessment (eCCA) procedure.
145. The non-transitory computer-readable medium of clause 144, wherein the COT is defined by an end of the successful LBT procedure corresponding to the at least one beam and a maximum channel occupancy time (MCOT) value.
146. The non-transitory computer-readable medium of clause 144 or 145, wherein the transmission resource corresponds to the at least one beam corresponding to the successful LBT procedure.
147. The non-transitory computer-readable medium of any of clauses 144-146, wherein the APG includes a timestamp of the successful LBT procedure.
148. The non-transitory computer-readable medium of clause 142 or 143, wherein the LBT procedure is a short clear channel assessment (CCA) procedure.
149. The non-transitory computer-readable medium of any of clauses 141-148, further comprising code to perform a base station LBT procedure prior to transmitting the PG, wherein the APG is received on a COT defined by an end of the base station LBT procedure and a maximum channel occupancy time (MCOT) value.
150. The non-transitory computer-readable medium of any of clauses 141-148, wherein the APG is received outside of a channel occupancy time (COT) as a contention-free transmission.
151. The non-transitory computer-readable medium of clause 150, wherein the PG indicates that uplink data is not allowed on the transmission resource.
152. The non-transitory computer-readable medium of any of clauses 141-151, wherein the APG is a physical uplink shared channel (PUSCH) scheduled by the PG.
153. The non-transitory computer-readable medium of any of clauses 141-152, wherein the PG is a downlink control information (DCI).
154. The non-transitory computer-readable medium of clause 153, wherein the DCI dynamically schedules the APG on the transmission resource or activates a configured grant for the transmission resource.
155. The non-transitory computer-readable medium of clause 153 or 154, wherein the DCI includes a field indicating the plurality of beams based on a configured mapping of field values to sets of beams.
156. The non-transitory computer-readable medium of any of clauses 141-155, wherein the LBT report is a multi-beam channel state information (CSI) report.
157. The non-transitory computer-readable medium of any of clauses 141-156, wherein the LBT procedure for each of the indicated plurality of beams is time division multiplexed (TDM).
158. The non-transitory computer-readable medium of any of clauses 141-156, wherein the LBT procedure for each of the indicated plurality of beams is space division multiplexed (SDM).
159. The non-transitory computer-readable medium of any of clauses 141-156, wherein the LBT procedure for each of the indicated plurality of beams is performed on a wider beam including a group of the plurality of beams.
160. The non-transitory computer-readable medium of clause 159, wherein the report includes an indication of a result of the LBT procedure for the group of the plurality of beams.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method of wireless communication, comprising, at a user equipment (UE):
receiving a pre-grant (PG) indicating a plurality of beams and a transmission resource;
performing a listen before talk (LBT) procedure on each beam of the indicated plurality of beams; and
transmitting an acknowledgment to the pre-grant (APG) including a LBT report for the indicated plurality of beams on the transmission resource, the LBT report indicating a result of the LBT procedure for each beam of the indicated plurality of beams.

2. The method of claim 1, wherein the result for at least one beam of the indicated plurality of beams is a successful LBT procedure, and wherein a transmitter is allowed to transmit a downlink transmission on the at least one beam during a channel occupancy time (COT).

3. The method of claim 2, further comprising receiving the downlink transmission on the at least one beam with the successful LBT procedure.

4. The method of claim 2, wherein the LBT procedure is a an extended clear channel assessment (eCCA) procedure.

5. The method of claim 4, wherein the COT is defined by an end of the successful LBT procedure corresponding to the at least one beam and a maximum channel occupancy time (MCOT) value.

6. The method of claim 4, wherein the transmission resource corresponds to the at least one beam with the successful LBT procedure.

7. The method of claim 4, wherein the APG includes a timestamp of the successful LBT procedure.

8. The method of claim 2, wherein the LBT procedure is a short clear channel assessment (CCA) procedure.

9. The method of claim 1, wherein the APG is transmitted on a COT is defined by an end of an LBT procedure performed prior to the PG and a maximum channel occupancy time (MCOT) value.

10. The method of claim 1, wherein the APG is transmitted outside of a channel occupancy time (COT) as a contention-free transmission.

11. The method of claim 10, wherein the PG indicates that only control signaling is allowed on the transmission resource.

12. The method of claim 1, wherein the APG is a physical uplink shared channel (PUSCH) scheduled by the PG.

13. The method of claim 1, wherein the PG is a downlink control information (DCI).

14. The method of claim 13, wherein the DCI includes a field indicating activated beams based on a configured mapping of field values to sets of beams.

15. The method of claim 1, wherein the LBT report is a multi-beam channel state information (CSI) report.

16. The method of claim 1, wherein the LBT procedure for each beam of the indicated plurality of beams is time division multiplexed (TDM) or space division multiplexed (SDM).

17. The method of claim 1, wherein performing the LBT procedure for each beam of the indicated plurality of beams comprises performing an LBT procedure on a wider beam including a group of the plurality of beams.

18. A method of wireless communication, comprising, at a base station:
transmitting a pre-grant (PG) indicating a plurality of beams and a transmission resource to a user equipment (UE); and
receiving an acknowledgment to the pre-grant (APG) on the transmission resource, the APG including a listen before talk (LBT) report indicating a result of a LBT procedure for each beam of the indicated plurality of beams.

19. The method of claim 18, wherein the result for at least one beam of the indicated plurality of beams is a successful LBT procedure, and wherein the base station is allowed to transmit a downlink transmission on the at least one beam during a channel occupancy time (COT).

20. The method of claim 19, further comprising transmitting a downlink transmission on the at least one beam during the COT.

21. The method of claim 19, wherein the LBT procedure is an extended clear channel assessment (eCCA) procedure, and wherein the APG includes a timestamp of the successful LBT procedure.

22. The method of claim 21, further comprising performing a base station LBT procedure prior to transmitting the PG, wherein the APG is received on a COT defined by an end of the base station LBT procedure and a maximum channel occupancy time (MCOT) value.

23. An apparatus for wireless communication at a user equipment (UE), comprising:
a memory storing computer-executable instructions; and
at least one processor coupled to the memory and configured to execute the instructions to:
receive a pre-grant (PG) indicating a plurality of beams and a transmission resource;
perform a listen before talk (LBT) procedure on each beam of the indicated plurality of beams; and
transmit an acknowledgment to the pre-grant (APG) including a LBT report for the indicated plurality of beams on the transmission resource, the LBT report indicating a result of the LBT procedure for each beam of the indicated plurality of beams.

24. The apparatus of claim 23, wherein the result for at least one beam of the indicated plurality of beams is a successful LBT procedure, and wherein a transmitter is allowed to transmit a downlink transmission on the at least one beam during a channel occupancy time (COT).

25. The apparatus of claim 24, wherein the at least one processor is configured to receive the downlink transmission on the at least one beam with the successful LBT procedure.

26. The apparatus of claim 24, wherein the LBT procedure is an extended clear channel assessment (eCCA) procedure, wherein the COT is defined by an end of the successful LBT procedure corresponding to the at least one beam and a maximum channel occupancy time (MCOT) value, and wherein the APG includes a timestamp of the successful LBT procedure.

27. An apparatus for wireless communication at a base station, comprising:
a memory storing computer-executable instructions; and
at least one processor coupled to the memory and configured to execute the instructions to:
transmit a pre-grant (PG) indicating a plurality of beams and a transmission resource to a user equipment (UE); and
receive an acknowledgment to the pre-grant (APG) on the transmission resource, the APG including a listen before talk (LBT) report indicating a result of a LBT procedure for each beam of the indicated plurality of beams.

28. The apparatus of claim 27, wherein the result for at least one beam of the indicated plurality of beams is a successful LBT procedure, and wherein the base station is allowed to transmit a downlink transmission on the at least one beam during a channel occupancy time (COT).

29. The apparatus of claim 28, wherein the LBT procedure is an extended clear channel assessment (eCCA) procedure, and wherein the COT is defined by an end of the successful LBT procedure corresponding to the at least one beam and a maximum channel occupancy time (MCOT) value.

30. The apparatus of claim 27, wherein the at least one processor is configured to perform a base station LBT procedure prior to transmitting the PG, wherein the APG is received on a COT defined by an end of the base station LBT procedure and a maximum channel occupancy time (MCOT) value.
